(19) United States
(12) Patent Application Publication
(10) Pub. No.: US 2021/0376688 A1
(43) Pub. Date: Dec. 2, 2021

(54) Electric Motor for a Wheel Brake Actuator, Wheel Brake Actuator and Method of Controlling a Cooling System of an Electric Motor

(71) Applicant: KNORR-BREMSE Systeme fuer Nutzfahrzeuge GmbH, Muenchen (DE)

(72) Inventors: Michael BLESSING, Muenchen (DE); Andreas BUCH, Taufkirchen (DE); Matthias KLINGNER, Moorenweis (DE); Csaba KOKREHEL, Budapest (HU); Csaba MLINARCSEK, Budapest (HU); Huba NEMETH, Budapest (HU); Wolfgang PAHLE, Bad Wiessee (DE); Andras SIPOS, Muenchen (DE); Janos SZABO, Budapest (HU); Viktor TIHANYI, Budapest (HU); Robert TRIMPE, Wessling (DE)

(21) Appl. No.: 17/277,171

(22) PCT Filed: Sep. 9, 2019
(86) PCT No.: PCT/EP2019/073933

§ 371 Date: Mar. 17, 2021

(30) Foreign Application Priority Data
Sep. 18, 2018 (EP) 18195248.2

(51) Int. Cl. H02K 5/20; H02K 9/20; B60T 5/00; B60T 13/74; F16D 65/78

(52) U.S. Cl. CPC H02K 5/203; H02K 9/20; F16D 2065/788; B60T 13/741; F16D 65/78; B60T 5/00

(57) ABSTRACT

An electric motor for actuating a wheel brake actuator includes a stator and a rotor. The electric motor further includes a cooling system for a liquid coolant to cool one or more parts of the electric motor. A wheel brake actuator includes the electric motor. A method is provided to control the cooling system of the electric motor for actuating the wheel brake actuator.

### BACKGROUND AND SUMMARY OF THE INVENTION

The present invention relates to electrical motors for actuating wheel brake actuators, and wheel brake actuators containing such electrical motors. Further, the invention provides a method of controlling a cooling system of an electric motor.

Electro-mechanic, including electro-pneumatic, wheel brake actuators are commonly used on commercial vehicles. Such wheel brake actuators generate significant heat dissipation during operation which is increased in comparison with mechanic wheel-brake actuators due to inclusion of electric motors. High temperatures decrease a wear-resistance of the electrical motors and other components of the electro-mechanic wheel brake actuators. Therefore, an efficient cooling mechanism for electro-mechanic wheel brake actuators is desirable.

At present, air cooling systems are used to cool down wheel brake actuators and, particularly, electric motors for actuating these wheel brake actuators. However, the efficiency of the air cooling systems for the wheel brake actuators is limited by the air convection which depends directly on the air circulation and hence velocity of the vehicle. A convection coefficient is small at a low speed due to small air velocities and high bulk air temperatures around the wheel brake actuator. Therefore, at low speed the cooling is insufficient, since the heat removal is significantly limited due to the low convection coefficient. Consequently, an increased necessity to remove heat typically exists when the vehicle has slowed down or already stopped to release stress of the wheel actuator components.

It is an object of the present invention to overcome the disadvantages of the prior art, particularly to provide an alternative cooling system which increases efficiency of cooling of the electrical motors of the wheel brake actuators, specifically upon a slow speed operation, and improves the wear-resistance of the wheel brake actuators.

The object is solved by the subject matter of the independent claims.

According to the invention, an electric motor for actuating a wheel brake actuator comprises a stator, a rotor, and a cooling system for a cooling fluid to cool one or more parts of the electric motor. Due to a higher heat capacity of the cooling fluid in comparison to air, the efficiency of the electric motor cooling, particularly at a low-speed operation, is improved. The cooling fluid may comprise one or more of a liquid coolant, gaseous coolant, solid coolant or combination thereof.

According to an embodiment, the electric motor further comprises a liquid pump configured to supply the cooling fluid to the cooling system. The electric motor may also be connected to a cooling device for cooling a cooling fluid. The cooling device may comprise a compressor based refrigerator or an electric cooling device comprising, for example, a Peltier element.

According to a further embodiment, the cooling system comprises a cooling layer which is arranged on one or more parts of the electric motor to cool down the electric motor due to evaporating of the cooling fluid supplied to the cooling layer.

According to an alternative embodiment, the cooling system comprises a cooling jacket for the cooling fluid, the cooling jacket comprising one or more parts being arranged opposite one or more parts of the electric motor, wherein a cooling channel for passing the cooling fluid is defined between the one or more parts of the cooling jacket and the one or more parts of the electric motor opposite the one or more parts of the cooling jacket.

According to an alternative embodiment, the cooling system comprises a cooling jacket for the cooling fluid, the cooling jacket being arranged in contact with one or more parts of the electric motor, the cooling jacket comprising a cooling channel for passing the cooling fluid. The cooling channel provides an improved control of the flow velocity of the cooling fluid and the possibility to vary or define the order in which the cooling fluid is supplied to different parts of the electric motor. For example, it can be efficient to define the cooling channel in such a manner on the electric motor that electronic components arranged on the electric motor are cooled first by the cooling fluid and part of the electric motor are subsequently cooled. Hence the path of the cooling channel on the electric motor is arranged so that components that need to be cooled primarily are arranged upstream of other components that require subordinated cooling and are arranged downstream in the cooling channel.

According to a further embodiment, the cooling jacket comprises the shape of a cylinder or a portion thereof surrounding at least a portion of the electric motor and comprising an inlet port of the cooling channel for an inlet of the cooling fluid into the cooling channel and an outlet port of the cooling channel for an outlet of the cooling fluid from the cooling channel. A cylindrical shape of the cooling jacket conforms to the shape of the electric motor and hence provides a good contact with the electric motor and its outer surface and good cooling efficiency.

According to another embodiment, the stator comprises additional components, particularly electronic components, arranged adjacent to or above an outer surface of the stator and wherein the cooling channel extends in contact with or adjacent at least some of the additional components and a portion of the outer surface of the stator free from the additional components. This provides a selective cooling of the components and parts of the electric motor and increases the overall speed of cooling down the electric motor. An additional housing or additional housings may be provided for the electronic components.

According to yet another embodiment, a flow direction of the cooling fluid through the cooling channel is arranged such that the cooling fluid after entering the inlet port first comes into contact with or flows above or adjacent at least some of the additional components and subsequently one or more portions of the outer surface of the stator free from the additional components before exiting the outlet port. Consequently, the electrical components which are more sensitive to the heat are cooled first and the additional protection of the electrical components from the destruction is provided.

According to a further embodiment, the cooling system comprises one or more secondary cooling channels separated from the primary cooling channel, the one or more secondary cooling channels being in contact with, above or adjacent one or more parts of the electric motor for cooling the one or more parts.

According to a further embodiment, the cooling system provides cooling, heating or thermo-control of one or more parts of the electric motor including the additional components, particularly the electronic components.

According to another aspect of the present invention, a wheel brake actuator comprising an electric motor including the above described embodiments is provided.

According to an embodiment, the cooling jacket at least partially forms a part of a housing of the wheel brake actuator and the inlet port and the outlet port of the cooling jacket are formed in the housing of the wheel brake actuator. This configuration can simplify the construction and provides a higher integration of the actuator.

According to another embodiment, the cooling system is arranged between the housing of the wheel brake actuator and the outer surface of the stator of the electric motor.

According to another aspect of the present invention, a method of controlling a cooling system of an electric motor for actuating a wheel brake actuator is provided.

The method includes steps of: receiving a temperature signal by a controller from one or more temperature sensors coupled to the Electric motor at fixed time intervals; comparing at the controller the temperature signal with a threshold value; and if the temperature signal is above the threshold value, providing a control signal by the controller to supply a cooling fluid to the cooling system.

According to an embodiment, the threshold value is pre-determined based on temperature history of the electric motor or dynamically determined during the electric motor operation. The temperature history can be stored in a data base in a memory.

Preferred embodiments are the subject of the dependent claims.

It is noted that the method according to the invention can be utilized such that it realizes an electric motor according to the described aspects of the invention, and vice versa.

The following detailed description refers to the accompanying drawings. The same reference numbers may be used in different drawings to identify the same or similar elements. In the following description, for purposes of explanation and not limitation, specific details are set forth such as particular structures, functionality etc. in order to provide a thorough understanding of the various aspects of the claimed invention.

It will be apparent to those skilled in the art having the benefit of the present disclosure that the various aspects of the invention claimed may be practiced in other examples that depart from these specific details. In certain instances, descriptions of well-known devices and methods are omitted so as not to obscure the description of the present invention with unnecessary detail.

### BRIEF DESCRIPTION OF THE DRAWINGS

FIG. 1 is a schematic cross-sectional view of an electric motor according to one of the embodiments the invention;

FIG. 2 is a general view of the electric motor according to FIG. 1;

FIG. 3 is a flowchart of an exemplary method according to the present invention; and

FIG. 4 is a schematic arrangement of the interaction between the electric motor and the cooling system.

### DETAILED DESCRIPTION OF THE DRAWINGS

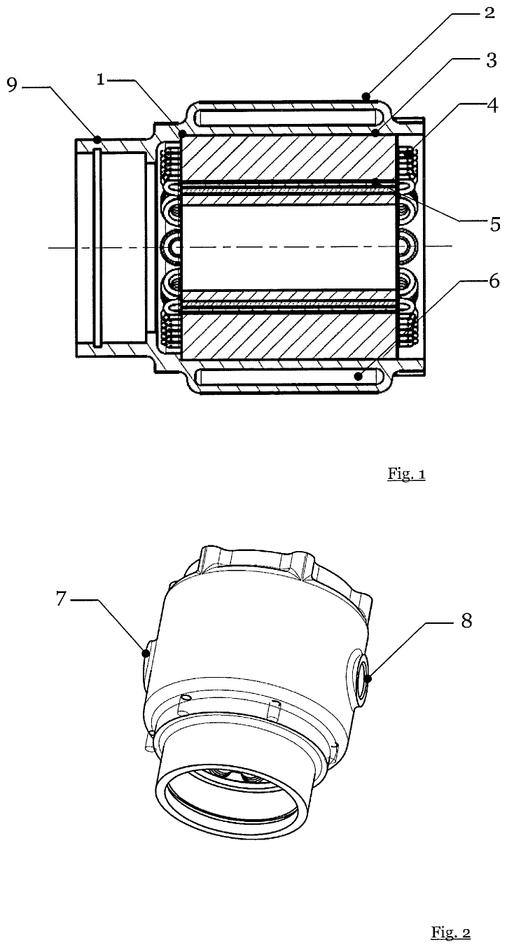

In an embodiment illustrated in FIG. 1, an electric motor 1 is included in a cooling jacket 2 of a cooling system 11 (not shown in FIG. 1), wherein the cooling jacket 2 is formed as a part of a housing 9 of a wheel brake actuator. The force, in particular, linear force of the wheel brake actuator is generated by the electric motor 1, comprising a stator 3 and a rotor 5. The stator 3 contains coils 4 of the electric motor 1. The stator 3 is fixed to the housing 9 of the wheel brake actuator, particularly, to its part forming the cooling jacket 2 and is adjacent to a wall of the cooling jacket 2. The cooling jacket 2 is arranged in contact with one or more parts of the electric motor 1. The cooling jacket 2 comprises a cooling channel 6 for passing a cooling fluid.

Referring to FIG. 2, the cooling jacket 2 has the shape of a cylinder which surrounds at least a portion of the electric motor 1. The cooling jacket 2 comprises an inlet port 7 of the cooling channel 6 for an inlet of the cooling fluid into the cooling channel 6 and an outlet port 8 of the cooling channel 6 for an outlet of the cooling fluid from the cooling channel 6. A pump for supplying a cooling fluid can be connected to the inlet port 7. Furthermore, the inlet port 7 and the outlet port 8 can be connected to a cooling device to provide a closed cooling cycle.

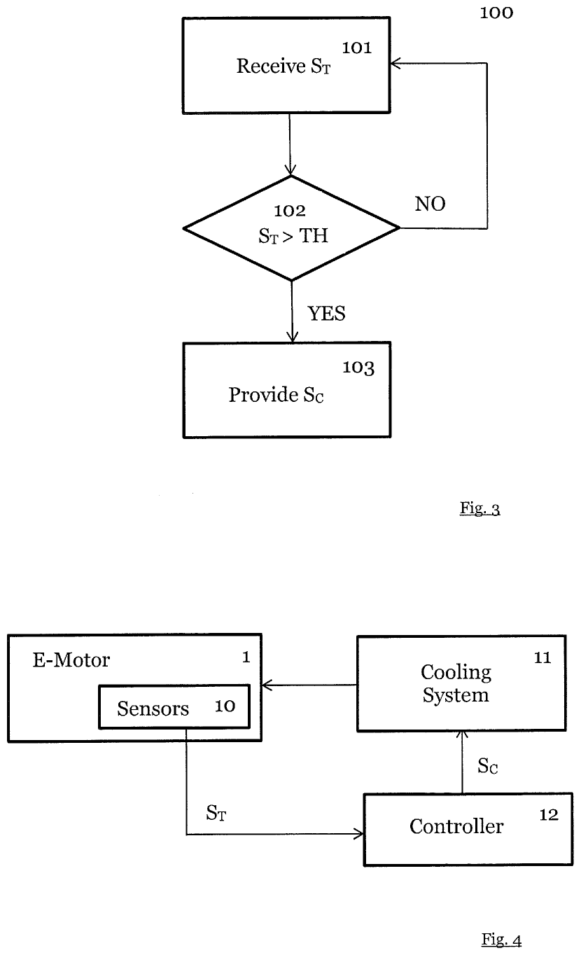

With regard to FIG. 3, a method 100 of controlling of a cooling system of an electric motor for actuating a wheel brake actuator is illustrated. A controller of the cooling system receives at a step 101 a temperature signal St from one or more temperature sensors coupled to the electric motor. The temperature signal St is received periodically at fixed time intervals. After the temperature signal St is received, the controller compares at a step 102 the received temperature signal St with a threshold value TH. The threshold value TH may be pre-determined based on a temperature history of the electric motor in different operating conditions and stored in a database connected to the controller. Alternatively, the threshold value TH may be dynamically determined during the electric motor operation based on the temperatures defined by the temperature signal received at the fixed time intervals. If the controller determines at the step 102 that the temperature signal St is above the threshold value TH, the controller provides at a step 103 a control signal Sc to the cooling device and or the pump to supply a cooling fluid to the cooling system. After the cooling fluid is supplied to the cooling system, the cooling system starts cooling the electric motor. If the controller determines that the temperature signal St drops below the threshold value TH or at least becomes equal to the threshold value TH, the controller may provide an interruption signal to interrupt supplying the cooling fluid to the cooling system. Thus, the consumption power for supplying an cooling the cooling fluid is decreased and the cooling system operates only when it is required due to the operation conditions of the electric motor.

Referring to FIG. 4, the controller 12 is illustrated in connection with the electric motor 1 and the cooling system 11. The temperature signal St is received at the controller 12 from the one or more temperature sensors 10 coupled to the electric motor 1. After the controller 12 performs a comparing step 102 illustrated in FIG. 3, the controller 12 sends the control signal Sc either to supply a cooling fluid to the cooling system 11 or to interrupt supplying the cooling fluid to the cooling system 11. The control signal Sc may be supplied to a liquid pump configured to supply the cooling fluid to the cooling system 11. The cooling system 11 then starts or interrupts cooling the electric motor 1.

The features disclosed in the above description, the figures and the claims may be significant for the realization of the invention in its different embodiments individually as in any combination.

### REFERENCE SIGN LIST

1 electric motor
2 cooling jacket
3 stator
4 coils of stator
5 rotor
6 cooling channel
7 inlet port
8 outlet port
9 housing of wheel brake actuator
10 sensors
11 cooling system
12 controller

1.-15. (canceled)

16. An electric motor for actuating a wheel brake actuator, the electric motor comprising:
a stator;
a rotor; and
a cooling system for a cooling fluid to cool one or more parts of the electric motor.

17. The electric motor of claim 16, further comprising:
a pump configured to supply the cooling fluid to the cooling system.

18. The electric motor of claim 17, wherein
the cooling system comprises a cooling layer which is arranged on one or more parts of the electric motor to cool down the electric motor based on evaporation of the cooling fluid supplied to the cooling layer.

19. The electric motor of claim 16, wherein
the cooling system comprises a cooling jacket for the cooling fluid,
the cooling jacket comprises one or more parts that are arranged opposite the one or more parts of the electric motor, and
a cooling channel for passing the cooling fluid is defined between the one or more parts of the cooling jacket and the one or more parts of the electric motor opposite the one or more parts of the cooling jacket.

20. The electric motor of claim 16, wherein
the cooling system comprises a cooling jacket for the cooling fluid,
the cooling jacket is arranged in contact with the one or more parts of the electric motor, and
the cooling jacket comprises a cooling channel for passing the cooling fluid.

21. The electric motor of claim 19, wherein
the cooling jacket has a shape of a cylinder or a portion thereof surrounding at least a portion of the electric motor, and
an inlet port of the cooling channel for an inlet of the cooling fluid into the cooling channel and an outlet port of the cooling channel for an outlet of the cooling fluid from the cooling channel.

22. The electric motor of claim 19, wherein
the stator comprises additional electronic components, arranged adjacent to or above an outer surface of the stator, and
the cooling channel extends in contact with or adjacent at least some of the additional electronic components and a portion of the outer surface of the stator free from the additional electronic components.

23. The electric motor of claim 22, wherein
a flow direction of the cooling fluid through the cooling channel is arranged such that the cooling fluid, after entering an inlet port, first comes into contact with or flows above or adjacent at least some of the additional electronic components and subsequently one or more portions of the outer surface of the stator free from the additional components, before exiting an outlet port.

24. The electric motor of claim 19, wherein
the cooling system comprises one or more secondary cooling channels separated from the cooling channel, and
the one or more secondary cooling channels are in contact with, above or adjacent one or more parts of the electric motor for cooling the one or more parts.

25. The electric motor of claim 22, wherein
the cooling system provides cooling, heating or thermo-control of the one or more parts of the electric motor, including the additional electronic components.

26. A wheel brake actuator comprising an electric motor according to claim 16.

27. The wheel brake actuator of claim 26, wherein
a cooling jacket at least partially forms a part of a housing of the wheel brake actuator, and an inlet port and an outlet port of the cooling jacket for the cooling fluid are formed in the housing of the wheel brake actuator.

28. The wheel brake actuator of claim 26, wherein
the cooling system is arranged between the housing of the wheel brake actuator and an outer surface of the stator of the electric motor.

29. A method of controlling a cooling system of an electric motor for actuating a wheel brake actuator, the method comprising the steps of:
receiving, at fixed time intervals, a temperature signal by a controller from one or more temperature sensors coupled to the electric motor;
comparing, at the controller, the temperature signal with a threshold value; and
when the temperature signal is above the threshold value, providing a control signal, by the controller, to supply a cooling fluid to the cooling system.

30. The method of claim 29, wherein
the threshold value is pre-determined based on temperature history of the electric motor or determined dynamically during electric motor operation.
